(19) United States
(12) Patent Application Publication
(10) Pub. No.: US 2022/0368499 A1
(43) Pub. Date: Nov. 17, 2022

(54) UPLINK TRANSMISSION IN PRECONFIGURED RESOURCES

(71) Applicant: Sony Group Corporation, Tokyo (JP)

(72) Inventors: Shin Horng WONG, Basingstoke (GB); Martin Warwick BEALE, Basingstoke (GB)

(73) Assignee: Sony Group Corporation, Tokyo (JP)

(21) Appl. No.: 17/629,783

(22) PCT Filed: Jul. 24, 2020
(86) PCT No.: PCT/EP2020/071009

§ 371 Date: Jan. 25, 2022

(30) Foreign Application Priority Data
Aug. 2, 2019 (EP) 19189896.4

(51) Int. Cl. H04L 5/00; H04W 68/02; H04W 76/10

(52) U.S. Cl. CPC H04L 5/0053; H04W 68/02; H04W 76/10

(57) ABSTRACT

A communications device configured to transmit data or receive data is provided. The communications device comprises transceiver circuitry configured to transmit signals and receive signals via a wireless access interface, and controller circuitry configured in combination with the transceiver circuitry to monitor a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received.

### BACKGROUND

### Field of Disclosure

The present disclosure relates to communications devices, infrastructure equipment and methods for the transmission of data by a communications device in a wireless communications network.

The present application claims the Paris Convention priority of European patent application number EP19189896.4, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to routinely and efficiently support communications with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes the so-called “Internet of Things”, or IoT for short. The 3GPP has proposed in Release 13 of the 3GPP specifications to develop technologies for supporting narrowband (NB)-IoT and so-called enhanced MTC (eMTC) operation using a LTE/4G wireless access interface and wireless infrastructure. More recently, there have been proposals to build on these ideas in Release 14 of the 3GPP specifications with so-called enhanced NB-IoT (eNB-IoT) and further enhanced MTC (feMTC), and in Release 15 of the 3GPP specifications with so-called further enhanced NB-IoT (feNB-IoT) and even further enhanced MTC (efeMTC); see, for example, [1], [2], [3], [4]. The IoT is further enhanced in 3GPP by the introduction of two additional Release 16 Work Items, namely A-MTC (Additional Machine Type Communications Enhancements) [5] and A-NB-IoT (Additional Enhancement for Narrowband Internet of Things) [6].

One approach currently considered to be of interest in the context of these technologies is the support of uplink transmissions on preconfigured uplink resources (PUR). That is to say, the support of data transmission by a terminal device using radio resources which are not specifically allocated to the terminal device on request for a particular transmission, but which the terminal device is preconfigured to use. It is expected this approach will help reduce the amount of signalling overhead associated with certain uplink transmissions, and consequently also help reduce power consumption by terminal devices making transmissions using PUR.

The presently named inventors have recognized the desire to support transmissions on preconfigured uplink resources gives rise to new challenges that need to be addressed to help optimise the operation of wireless telecommunications systems.

### SUMMARY OF THE DISCLOSURE

The present disclosure can help address or mitigate at least some of the issues discussed above.

Embodiments of the present technique can provide a communications device configured to transmit data or receive data. The communications device comprises transceiver circuitry configured to transmit signals and receive signals via a wireless access interface, and controller circuitry configured in combination with the transceiver circuitry to monitor a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received. In at least some arrangements of embodiments of the present technique, the communications device is configured to monitor the PUR SS for reception of the potential paging instruction only if the communications device transmitted uplink data in the PUR.

In some embodiments of the present technique, the communications device is further configured to determine whether at least part of the PUR SS overlaps in time with at least part of a second set of radio resources of the wireless access interface forming a common search space, CSS, the CSS providing an opportunity for the communications device to receive the potential paging instruction, and to monitor the PUR SS for reception of the potential paging instruction only if the communications device determines that the at least part of the PUR SS overlaps in time with the at least part of the CSS.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates the Pre-configured Uplink Resource Search Space (PUR SS) window;

FIG. 5 shows an example of a User Equipment (UE) skipping a PUR;

FIG. 6 shows an example of how the network may page a UE for an RRC connection;

FIG. 7A shows a first example part schematic, part message flow diagram representation of a wireless communications network comprising a communications device and an infrastructure equipment in accordance with embodiments of the present technique;

FIG. 7B shows a second example part schematic, part message flow diagram representation of a wireless communications network comprising a communications device and an infrastructure equipment in accordance with embodiments of the present technique;

FIG. 8 shows an example of how a UE may monitor the PUR SS window for an uplink grant after skipping a PUR in accordance with embodiments of the present technique;

FIG. 9A shows a first example implementation and operation, in flow diagram form, of a UE that is configured to receive an uplink grant in the PUR SS window when the PUR SS collides in time with the Common Search Space (CSS) in accordance with embodiments of the present technique;

FIG. 9B shows a second example implementation and operation, in flow diagram form, of a UE that is configured to receive an uplink grant in the PUR SS window when the PUR SS collides in time with the Common Search Space (CSS) in accordance with embodiments of the present technique;

FIG. 10A shows a first example implementation and operation, in flow diagram form, of a UE that is configured to receive a downlink grant in the PUR SS window when the PUR SS collides in time with the Common Search Space (CSS) in accordance with embodiments of the present technique;

FIG. 10B shows a second example implementation and operation, in flow diagram form, of a UE that is configured to receive a downlink grant in the PUR SS window when the PUR SS collides in time with the Common Search Space (CSS) in accordance with embodiments of the present technique;

FIG. 11A shows a first flow diagram illustrating a process of communications in a communications system in accordance with embodiments of the present technique; and

FIG. 11B shows a second flow diagram illustrating a process of communications in a communications system in accordance with embodiments of the present technique.

### DETAILED DESCRIPTION OF THE EMBODIMENTS

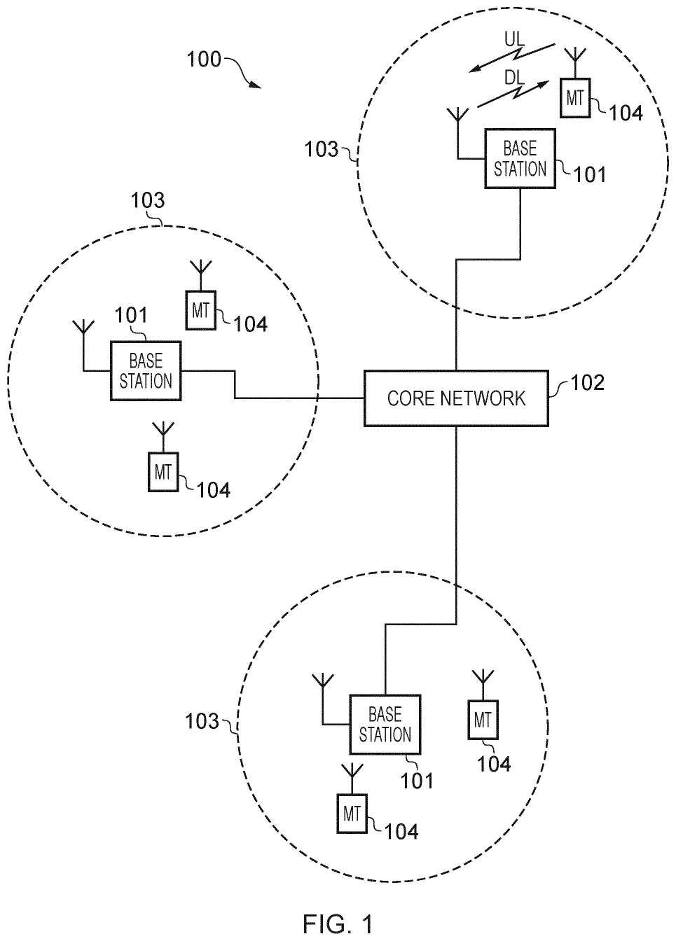

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (®) body, and also described in many books on the subject, for example, Holma H. and Toskala A [7]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

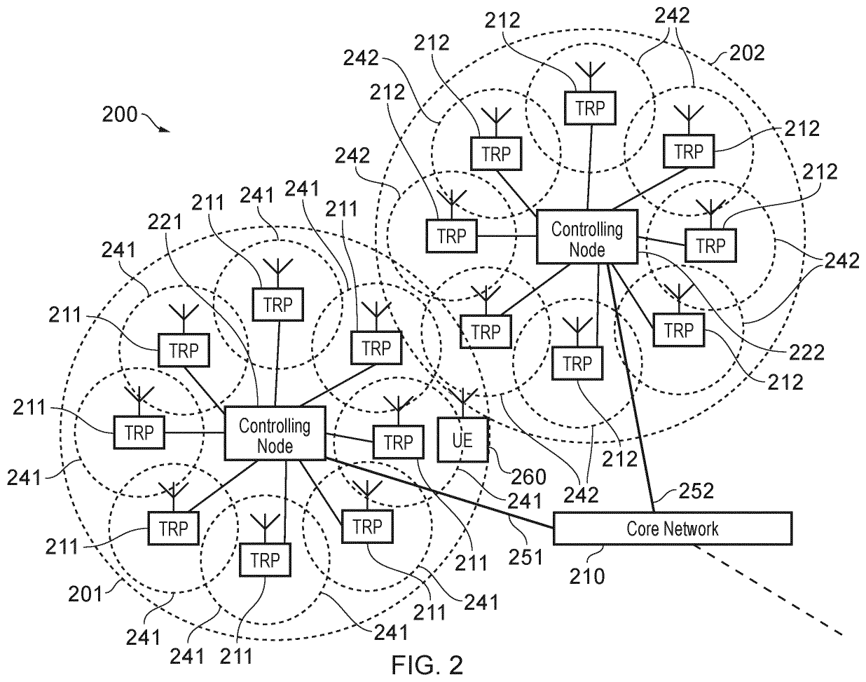

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

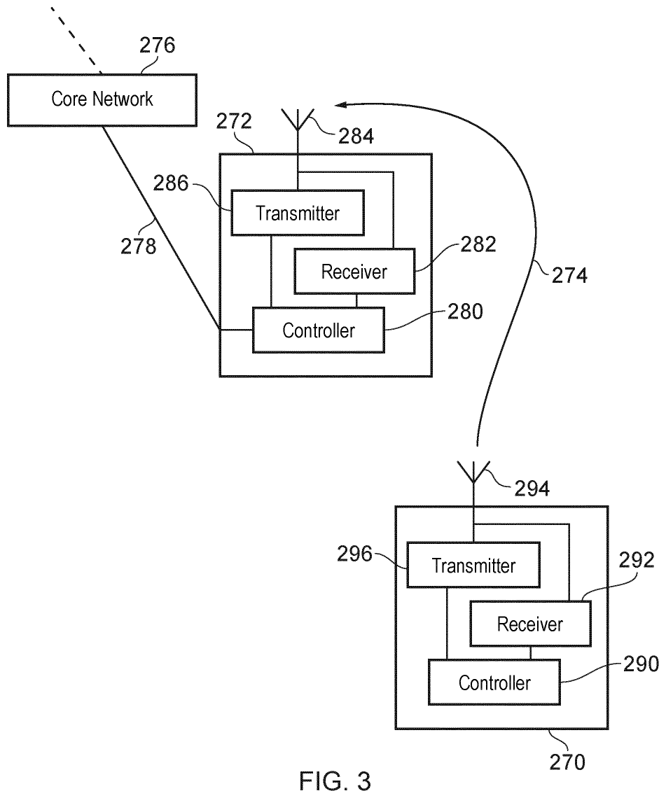

A more detailed illustration of a UE 270 and an example network infrastructure equipment 272, which may be thought of as an eNB 101 or a combination of a controlling node 221 and TRP 211, is presented in FIG. 3. As shown in FIG. 3, the UE 270 is shown to transmit uplink data to the infrastructure equipment 272 via resources of a wireless access interface as illustrated generally by an arrow 274. The UE 270 may similarly be configured to receive downlink data transmitted by the infrastructure equipment 272 via resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

Pre-Configured Uplink Resources (PUR)

Mobile communications networks such as the network 100 shown in FIG. 1 and the network 200 shown in FIG. 2 may support preconfigured uplink grant transmissions. A preconfigured uplink grant transmission comprises a transmission of data in accordance with a predefined configuration, for example in terms of pre-determined radio resources on a physical uplink shared channel (PUSCH) of a radio sub-frame structure used by a receiving entity such as an LTE-type base station 101 as shown in FIG. 1 and control units/controlling nodes 221, 222 and/or TRPs 211, 212 of the kind shown in FIG. 2. Thus a characteristic of certain pre-configured uplink resource (PUR) schemes is that a terminal device may be operable to transmit data in accordance with a predefined configuration (e.g. a dedicated PUR configuration for the terminal device). Because the PUR configuration is predefined, the terminal device may transmit data that has become available for uplink transmission in accordance with its PUR configuration (for example using time and frequency radio resources defined by the PUR configuration), without first needing to request a specific allocation of radio resources to transmit the data or to establish a radio resource control (RRC) connection, for example by performing a RACH (random access channel) procedure, if the terminal device is in an idle mode when data becomes available for transmission. The specific PUR configuration may be dedicated to a particular terminal device so the network is aware of which terminal device has transmitted the data based on the PUR configuration used (for example the radio resources used).

One of the objectives of Rel-16 A-MTC is to:
Specify support for transmission in preconfigured resources in idle and/or connected mode based on a single carrier frequency-division multiple access (SC-FDMA) waveform for UEs with a valid timing advance
   Both shared resources and dedicated resources can be discussed

The preconfigured resources under consideration are dedicated PUSCH resources for transmission in idle mode. Here, as described above, a set of periodic uplink resource is allocated to a UE to use in idle mode such that the UE does not need to perform a RACH procedure in order to transmit an item of uplink data over PUSCH, as long as the UE has a valid Timing Advance. The preconfigured uplink resource (PUR) is dedicated to the UE and so the network is aware which UE is performing the transmission.

A PUR configuration may include settings for parameters such as:
Timing Advance (TA) invalidation timer (i.e. an indication of the time after which the terminal device should determine a new timing advance);
Terminal device transmission power (i.e. an indication of the power the terminal device should use for its PUR transmissions);
Repetition (i.e. an indication of the degree of repetition (redundancy) the terminal device should use for its PUR transmissions);
MCS (i.e. an indication of a modulation and coding scheme the terminal device should use for its PUR transmissions);
Time and frequency resources (i.e. an indication of times and/or frequencies for radio resources the terminal device should use for its PUR transmissions);
Time offset (i.e. an indication of the time offset of PUR transmission opportunities for the terminal device relative to a predefined reference time point, for example the first sub-frame in a frame); and
Number of PUR allocations (i.e. an indication of how many PUR transmission opportunities are available for the terminal device to use for PUR transmissions according to the current PUR configuration before the PUR allocation lapses/is removed).

The PUSCH is transmitted using a hybrid automatic repeat request (HARQ) transmission where the UE would expect a HARQ acknowledgement (HARQ-ACK) feedback from the eNB to indicate whether the PUSCH is successfully decoded or not. In MTC, HARQ-ACK feedback is transmitted using downlink control information (DCI) carried by an MTC physical downlink control channel (MPDCCH). If the eNB fails to decode the PUSCH, it will send a DCI carrying an uplink grant to schedule for a PUSCH retransmission. Since Rel-15, an explicit ACK is introduced for MTC where the eNB sends a DCI indicating an ACK to the UE if the eNB successfully decoded the PUSCH. It should be noted that, prior to Rel-15, an explicit ACK is not sent and the absence of an uplink grant for a retransmission is in itself considered an ACK. The explicit ACK in Rel-15 is indicated using DCI Format 6-0A and Format 6-0B for CE Mode A and CE Mode B using predefined settings in the fields [8], i.e.:
Format 6-0A: All bits in the Resource Allocation are set to “1” and all other fields except “Flag format 6-0A/format 6-1A differentiation” and “DCI subframe repetition number” are set to “0”;
Format 6-0B: All bits in the MCS are set to “1” and all other fields except “Flag format 6-0A/format 6-1A differentiation” and “DCI subframe repetition number” are set to “0”.

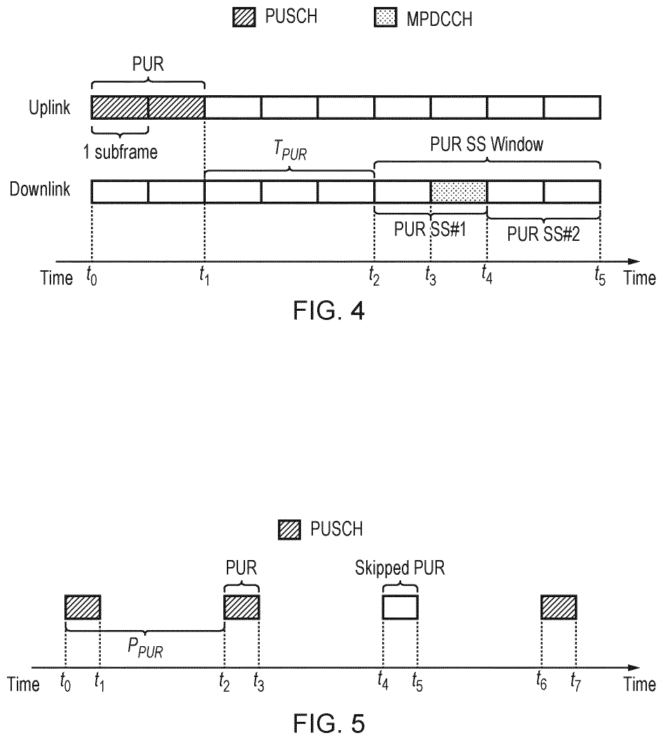

In order to provide HARQ-ACK feedback for PUSCH using PUR in idle mode, a PUR Search Space (PUR SS) is introduced. After a PUSCH transmission using PUR, the UE monitors for the PUR SS within a time window, i.e. a PUR SS Window after T_{PUR} ms (it should be noted that T_{PUR} is yet to be determined in 3GPP). An example is shown in FIG. 4, where one of the periodically occurring PUR is used for a PUSCH transmission between time t₀ and t₁ (e.g. for a PUSCH with 2x repetitions). After T_{PUR} ms, the UE monitors within a PUR SS Window between time t₂ and t₅ for an MPDCCH that carries either an ACK or an UL Grant for a retransmission. The PUR SS Window contains multiple PUR SS, and here it contains two PUR SS labelled as PUR SS #1 and PUR SS #2 where each PUR SS has a duration of 2 subframes. In this example, the MPDCCH is transmitted between time t₃ and t₄ using one of the MPDCCH candidates in PUR SS #1.

Although the PUR is intended for periodic traffic, e.g. a device that reports the temperature every hour, it is allowed for the UE to skip a PUR transmission, for example when the UE does not have any new data to transmit or the UE is trying to save battery power. That is the UE is not required to transmit at every PUR occasion. An example of skipped PUR is shown in FIG. 5, where a PUR is configured with a periodicity of P_{PUR}. Here the UE transmits a PUSCH in each PUR except the PUR between time t₄ and t₅, i.e. the UE skips a PUR occasion. The eNB would have to detect whether a PUSCH is transmitted or not in each PUR occasion. It is agreed in 3GPP that when the UE skips a PUR, the UE does not need to monitor the corresponding PUR SS since it does not expect any HARQ feedback from the eNB, and so stays in idle mode.

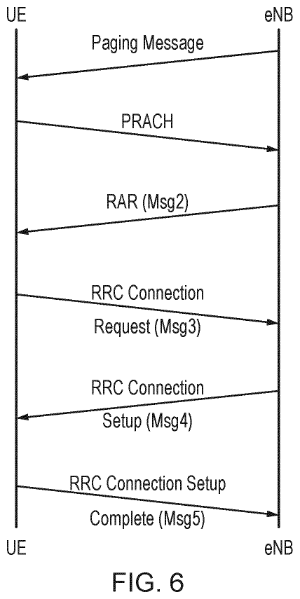

A UE in idle (or an inactive) mode monitors the Common Search Space (CSS Type 1) at every Paging Occasion for a potential MPDCCH carrying a DCI that either directly indicates an SI change or schedules a paging message (where the paging message is mapped to the PCCH (paging control channel), which is then mapped to the PCH (paging channel) transport channel, which is then mapped to the PDSCH) [9]. If the paging message contains the UE's ID (IMSI or TMSI), then the UE will detect that the paging message is intended for itself, and the UE will perform an RRC Connection procedure. The signalling diagram for paging a UE for RRC Connection is shown in FIG. 6, where the eNB firstly sends a paging message to the UE in a Paging Occasion. The UE, identifying its ID in the paging message will then perform a RACH process where it transmits a PRACH (preamble) to the eNB. Assuming the PRACH preamble is successfully received by the eNB, the eNB responds with a Random Access Response (RAR) (also known as Message 2) where the RAR provides an Uplink Grant for the UE to transmit an RRC Connection Request (also known as Message 3), as well as a timing advance value (such that the UE can change its timing to compensate for the round trip delay caused by its distance from the eNB). When the eNB receives Message 3, it responds with an RRC Connection Setup (or Message 4). The UE completes the RRC Connection with an RRC Connection Setup Complete (or Message 5).

It is noted in [10], [11], [12] that the CSS (Type 1) for paging may collide in time with the PUR SS and so an MTC UE would not be able to monitor both search spaces if they are in different narrowbands. It is proposed in [10] & [11] that the UE monitors the PUR SS, in which case the UE may miss a paging message. In [11], it is proposed that the PUR SS transmits a downlink grant to schedule PDSCH carrying downlink traffic to the UE, hence avoiding the need for the UE to connect to the network (i.e. instead of paging the UE to transmit downlink data, the downlink data is sent to the UE directly in IDLE mode). On the other hand in [12] it is proposed that the UE monitors the CSS (Type 1), in which case the UE would not be able to receive HARQ feedback from the eNB. There are a number of issues with these approaches:
The UE may not monitor the PUR SS when the UE skips a PUR, and hence the eNB would miss the opportunity to page the UE. It be noted here that the next paging occasion for the UE may be a few hours away;
The proposal in [11] of sending a DL Grant to the UE ignores the possibility that the eNB may want to perform an RRC Connection to the UE rather than just sending a single PDSCH. For example, the network may wish to re-configure the UE and/or perform a series of downlink and uplink data transmissions which is more efficient in an RRC Connected mode; and
Monitoring the CSS as proposed in [12] means the UE would miss the HARQ-ACK feedback after a PUR transmission. This is especially unfortunate for the case where the Paging Occasions do not have any messages for the UE (in which case the UE has unnecessarily sacrificed receiving HARQ-ACK feedback for the possibility of receiving a paging message that doesn't actually occur).

Embodiments of the present technique provide solutions which allow telecommunications networks and systems to handle the PUR SS and CSS (Type 1) collision in eMTC.

PUR SS and CSS for Paging Collision

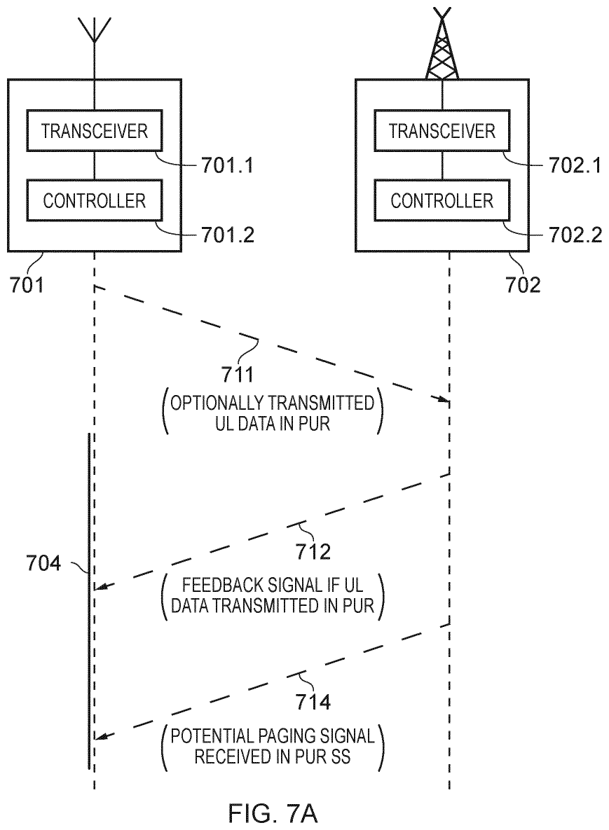

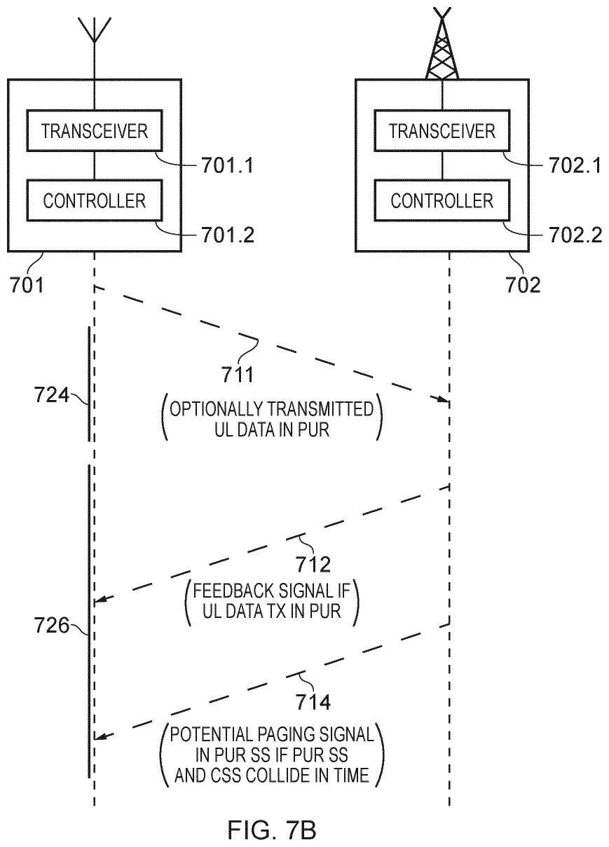

FIGS. 7A and 7B each show part schematic, part message flow diagram representations of a wireless communications network comprising a communications device 701 and an infrastructure equipment 702 in accordance with at least some embodiments of the present technique. The communications device 701 is configured to transmit data to or receive data from an infrastructure equipment 702, via a wireless access interface provided by the wireless communications network. The communications device 701 and the infrastructure equipment 702 each comprise a transceiver (or transceiver circuitry) 701.1, 702.1, and a controller (or controller circuitry) 701.2, 702.2. Each of the controllers 701.2, 702.2 may be, for example, a microprocessor, a CPU, or a dedicated chipset, etc.

As shown in the example of FIG. 7A, the transceiver circuitry 701.1 and the controller circuitry 701.2 of the communications device 701 are configured in combination to monitor 704 a first set of radio resources of the wireless access interface for reception of a potential paging instruction, the first set of radio resources forming a preconfigured uplink resource, PUR, search space, SS, associated with a PUR in which the communications device 701 may optionally transmit uplink data 711 to the infrastructure equipment 702 and comprising, when the communications device 701 transmits the uplink data 711, a feedback signal 712 received from the infrastructure equipment 702 indicating whether or not the uplink data 711 has been successfully received. In at least some arrangements of embodiments of the present technique, the communications device 701 is configured to monitor 704 the PUR SS for reception of the potential paging instruction 714 only if the communications device transmitted uplink data 711 in the PUR. In at least some arrangements of embodiments of the present technique described below, the paging instruction is a signal that instructs the UE to decode a paging message or to initiate or complete various stages of an RRC Connection process. Whereas the paging message discussed above with reference to FIG. 6 is mapped to a PCCH logical channel, the paging instruction is not necessarily mapped to the PCCH logical channel.

As shown in the example of FIG. 7B, the transceiver circuitry 701.1 and the controller circuitry 701.2 of the communications device 701 are configured in combination to determine 724 whether at least part of a first set of radio resources of the wireless access interface forming a preconfigured uplink resource, PUR, search space, SS, overlaps in time with at least part of a second set of radio resources of the wireless access interface forming a common search space, CSS, the PUR SS being associated with a PUR in which the communications device 701 may optionally transmit uplink data 711 to the infrastructure equipment 702 and comprising, when the communications device 702 transmits the uplink data 711, a feedback signal 712 received from the infrastructure equipment 702 indicating whether or not the uplink data 711 has been successfully received by the infrastructure equipment, and the CSS providing an opportunity for the communications device 701 to receive a potential paging instruction 714 from the infrastructure equipment 702, and to monitor 726, if the communications device 701 determines that the at least part of the PUR SS overlaps in time with the at least part of the CSS, the PUR SS for reception of the potential paging instruction 714 from the infrastructure equipment 702.

Essentially, embodiments of the present technique propose that the UE monitors the PUR SS for a potential paging instruction. In some arrangements of embodiments of the present technique, the UE monitors the PUR SS for potential paging instructions after it has transmitted a PUSCH using PUR regardless of whether its PUR SS collides with CSS Type 1 or not. This arrangement allows for the network to increase the number of paging opportunities beyond the configured Paging Occasions.

In some other arrangements of embodiments of the present technique, the UE monitors the PUR SS for the potential paging instruction even if it skipped a PUR, if the PUR SS collides in time with CSS Type 1 (paging CSS). This recognises that in the legacy system, although the UE can monitor the CSS Type 1 (since the UE does not monitor the corresponding PUR SS when it skips a PUR, and in the legacy system, the UE is free to monitor a search space other than PUR SS), the eNB may misdetect whether the UE skips a PUR or transmitted in a PUR, whereby the possibility of such misdetection reduces the reliability in selecting the search space (PUR SS or CSS) to send the paging instruction. Hence, solutions provided by embodiments of the present technique allow the network to reliably use a search space during a collision, and the UE to easily determine which search space to monitor during a collision.

In at least some arrangements of embodiments of the present technique, the UE monitors the PUR SS for potential paging instructions if the following conditions are both true:
the PUR SS collides in time with CSS Type 1 (paging CSS); and
the UE transmitted a PUSCH in the PUR.

In other words, the communications device is configured to determine whether at least part of the PUR SS overlaps in time with at least part of a second set of radio resources of the wireless access interface forming a common search space, CSS, the CSS providing an opportunity for the communications device to receive the potential paging instruction, and to monitor the PUR SS for reception of the potential paging instruction only if the communications device determines that the at least part of the PUR SS overlaps in time with the at least part of the CSS and only if the communications device transmitted uplink data in the PUR. It should be appreciated, however, that in other arrangements of embodiments of the present technique, the above conditions could be that the UE is configured to monitor the PUR SS for potential paging instructions if the PUR SS collides in time with the paging CSS and the UE did not transmit a PUSCH in the PUR (i.e. the UE skipped the PUR).

In contrast, in an arrangement of embodiments of the present technique if the UE had skipped PUR transmission, the UE monitors the CSS Type 1 (paging CSS) for potential paging instructions. This arrangement recognises that some eNB implementations will be able to detect whether the UE had skipped the PUR transmission or not (e.g. by detecting the presence/absence of demodulation reference symbols (DMRS) on PUR). In this case, both the UE and eNB know whether the UE skipped the PUR and both devices are synchronised in terms of which search space the UE is monitoring. In other words, the communications device is configured to determine whether at least part of a first set of radio resources of the wireless access interface forming a preconfigured uplink resource, PUR, search space, SS, overlaps in time with at least part of a second set of radio resources of the wireless access interface forming a common search space, CSS, the PUR SS being associated with a PUR in which the communications device may optionally transmit uplink data and comprising, when the communications device transmits the uplink data, a feedback signal indicating whether or not the uplink data has been successfully received, and the CSS providing an opportunity for the communications device to receive the potential paging instruction, to determine, if the communications device determines that the at least part of the PUR SS overlaps in time with the at least part of the CSS, that the communications device has not transmitted uplink data in the PUR, and to monitor the CSS for reception of the potential paging instruction.

It should be appreciated by those skilled in the art that the UE still monitors CSS Type 1 when it does not collide with the PUR SS. For example, in some of the above described arrangements of embodiments of the present technique, if the PUR SS collides with CSS Type 1, the UE monitors PUR SS— however when there is no collision, the UE monitors PUR SS when the PUR SS is active and monitors CSS Type 1 when CSS Type 1 is active. It should also be noted that the UE may not receive any paging instruction during the PUR SS Window when monitoring it for such a paging instruction and hence, in the description of embodiments of the present technique, and in the appended claims, such paging instructions for which the UE monitors are defined as being “potential” paging instructions when described from the point of view of the UE which doesn't know whether or not it will receive such a paging instruction. Of course, on the network side, an eNB knows when it does or doesn't transmit a paging instruction, and so the paging instructions actually transmitted by the eNB are not potential paging instructions. The following example arrangements of embodiments of the present technique describe how the UE receives a paging instruction when it monitors the PUR SS.

Paging Instruction Using an Uplink Grant

In the following arrangements of embodiments of the present technique described in this section of the present disclosure, the said potential paging instruction is sent to the UE using an UL Grant. In other words, the potential paging instruction is received within an uplink grant and comprises an indication of radio resources of the wireless access interface within which the communications device is to transmit an uplink signal, and wherein, if the communications device transmitted uplink data in the PUR, the uplink grant comprises the feedback signal.

In an arrangement of embodiments of the present technique, the said potential paging instruction is an UL grant scheduling a Message 3 (Msg3). That is, the UE transmits an RRC Connection Request using the resources scheduled by the UL grant. In other words, the uplink grant indicates that the communications device is to transmit, as the uplink signal, a Radio Resource Control, RRC, Connection Request message. This will be followed up by Msg4 and Msg5 to complete the RRC Connection. This arrangement recognises that the eNB may want the UE to connect to the network for multiple data exchange and here the eNB bypasses the need for the UE to perform a PRACH.

In some examples of the arrangement described in the above paragraph, if the UE receives an UL grant scheduling a Message 3, but the UE does not have a valid timing advance, it executes a normal PRACH procedure in order to send the Message 3. In other words, the communications device is configured to determine whether the communications device does not have a valid timing advance, and to transmit, if the communications device determines that it does not have a valid timing advance, a preamble signal.

Those skilled in the art would appreciate that an UL Grant can also be used to schedule a retransmission of a PUSCH using PUR or it can indicate an explicit ACK. Hence, the UE needs to distinguish between an UL Grant for Msg3 and an UL Grant for a retransmission or HARQ-ACK.

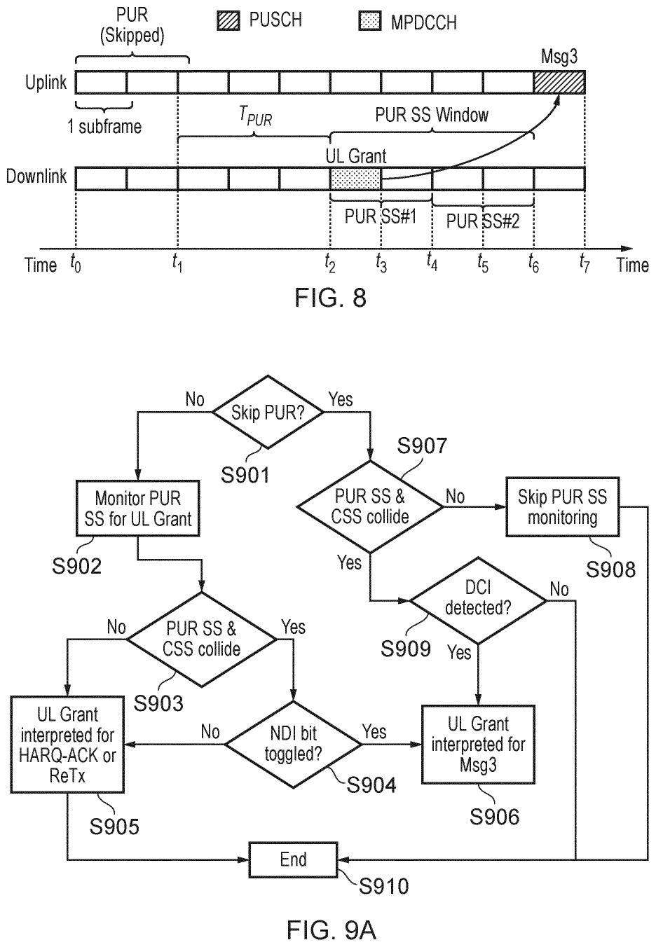

In an arrangement of embodiments of the present technique, the UE recognises an UL Grant transmitted by the eNB during the PUR SS Window is for the transmission of a Msg 3 if the UE had skipped a PUR prior to monitoring the PUR SS Window. That is if the UE had skipped a PUR then it should not expect any retransmission or explicit ACK and therefore if it detects an UL Grant during the PUR SS Window, then it must be for a Msg 3 transmission. In other words, the communications device is configured to determine, if the communications device did not transmit uplink data in the PUR, that the uplink grant indicates that the communications device is to transmit the RRC Connection Request message. An example is shown in FIG. 8, where a PUR occasion is available for a UE between time t₀ and t₁. However, the UE does not have any PUSCH to transmit thereby skipping the PUR. The corresponding PUR SS Window collides with CSS Type 1 and in accordance with embodiments of the present technique, the UE monitors the PUR SS. The UE detects an MPDCCH carrying a DCI with an UL Grant. Since the UE did not transmit any PUSCH during the PUR occasion, as per this arrangement, the UE determines that the UL Grant is for a Msg3.

In another arrangement of embodiments of the present technique, if the UE transmits a PUSCH in a PUR (i.e. did NOT skip the PUR), the first UL Grant is always used for HARQ feedback, i.e. retransmission or explicit ACK. The UE then further monitors for a subsequent UL Grant (if the PUR SS Window has not ended yet). In other words, if the communications device transmitted uplink data in the PUR, the uplink grant (that schedules the Msg3) is a second uplink grant received after a first uplink grant, and wherein the first uplink grant further comprises an indication of radio resources in which the communications device is to retransmit the uplink data if the feedback signal indicates that the uplink data has not been successfully received. If the UE skips the PUR, then the 1^{st} UL Grant is for Msg3 as per the arrangement described in the previous paragraph. In some implementations of this arrangement, the UE monitors for the further (second) UL Grant only if the PUR SS collides with CSS Type 1. In other words, the communications device is configured to determine whether at least part of the PUR SS overlaps in time with at least part of a second set of radio resources of the wireless access interface forming a common search space, CSS, the CSS providing an opportunity for the communications device to receive the potential paging instruction, and to monitor the PUR SS for reception of the second uplink grant only if the communications device determines that the at least part of the PUR SS overlaps in time with the at least part of the CSS.

In another arrangement of embodiments of the present technique, the DCI carrying an UL Grant that is transmitted during the PUR SS includes an indicator to indicate whether the UL Grant is for a retransmission/explicit ACK or it is for Msg3/Msg5 (see below paragraphs describing implementations in which the UL Grant schedules a Msg5 rather than a Msg3). In other words, if the communications device transmitted uplink data in the PUR, the communications device is configured to receive an uplink grant within the PUR SS, the uplink grant comprising an indication of radio resources of the wireless access interface and an indicator indicating whether the uplink grant comprises the potential paging instruction and therefore that the communications device is to transmit one of an RRC Connection Request and an RRC Connection Setup Complete message in the indicated radio resources or whether the uplink grant comprises the feedback signal and therefore that, if the feedback signal indicates that the uplink data has not been successfully received, the communications device is to retransmit the uplink data in the indicated radio resources. This is beneficial for a UE that transmitted a PUSCH using the PUR and therefore would expect a HARQ feedback from the eNB (i.e. it allows the UE to distinguish between different types of UL grant since the UE might be receiving either an UL Grant for re-transmission or an UL grant for Msg3).

In some examples of the arrangement described in the above paragraph, the said indicator is the NDI (New Data Indicator). That is, the NDI bit is toggled indicating a new PUSCH transmission rather than a retransmission of a previous PUSCH. In this case the new PUSCH transmission is for Msg3/Msg5 (see below paragraphs describing implementations in which the UL Grant schedules a Msg5 rather than a Msg3). In other words, the indicator comprises a bit which is toggled each time the communications device is to transmit a new uplink signal. It should be appreciated that the explicit ACK uses a predefined state, which can be recognised by the UE.

In another arrangement of embodiments of the present technique, if the UE transmits a PUSCH in a PUR, then the DCI sent during the PUR SS Window can be an UL Grant that allocates resources for both a Msg3 and also resources for the HARQ feedback. By providing resources for transmission of a Msg3, the UL grant acts as a paging instruction to the UE. In other words, if the communications device transmitted uplink data in the PUR, the communications device is configured to receive an uplink grant within the PUR SS, the uplink grant comprising both of the potential paging instruction and the feedback signal and an indication of a set of radio resources of the wireless access interface. That is the UL grant can be one of the following types:
The UL Grant includes resources ONLY for Msg3, which implicitly indicates an ACK to the UE's PUSCH. In other words, the communications device is configured to determine, if the uplink grant indicates that the communications device is to transmit only an RRC Connection Request message within the set of radio resources, that the feedback signal indicates that the uplink data has been successfully received;
The UL Grant provides resources both for transmission of an RRC Connection Request message in Msg3 and for the retransmission of the PUR PUSCH. In other words, the uplink grant indicates that the communications device is to transmit an RRC Connection Request message within the set of radio resources and that the communications device is to retransmit the uplink data within the set of radio resources;
UL Grant for only HARQ feedback retransmission for PUSCH. That is the eNB does not wish to page the UE for RRC Connection. In other words, the uplink grant indicates that the communications device is to only retransmit the uplink data within the set of radio resources; or
DCI indicating explicit ACK, i.e. using predefined bit settings in the DCI as per legacy systems. In other words, the feedback signal comprised within the uplink grant is an explicit acknowledgement that the uplink data was successfully received.

The UE can distinguish between UL Grant for Msg3, for PUR retransmission+Msg3 and for PUR retransmission only by implicit indication in the DCI. For example the Transport Block Size (TBS) and NDI bits can be used with the following mappings:
NDI toggled
   52 bits TBS=>Msg3
NDI not toggled
   TBS is within the set {300 bits, 700 bits, 1000 bits)=>PUR retransmission+Msg3
   other TBS, e.g. same TBS as the PUSCH transmitted using the PUR=>a PUR retransmission.

It should be appreciated by those skilled in the art that, for the arrangements of embodiments of the present technique as described herein where an indication in the UL Grant is used to tell the UE whether the UL Grant is scheduling a HARQ-ACK/Retransmission or providing a Paging Instruction, such arrangements are applicable to cases where the UE transmitted on a PUR regardless of whether its corresponding PUR SS collides with CSS Type 1 or not.

In another arrangement of embodiments of the present technique, the said potential paging instruction is an UL grant scheduling Msg5, i.e. RRC Connection Setup Complete. That is, the network connects the UE with a single message. This arrangement bypasses the RRC Connection Setup in Msg4 (it should be noted that most of the RRC configurations are performed in this Msg4 in the legacy system) by using the previous RRC configuration. That is, prior to the PUR configuration, the UE needs to connect to the network and would therefore be configured with the required RRC configurations. The UE then remembers this configuration when it moves back to idle mode and the UE can be directly moved to RRC CONNECTED mode with a Msg5 on the understanding that the aforementioned configuration will be used in RRC CONNECTED mode. In other words, the uplink grant indicates that the communications device is to transmit, as the uplink signal, an RRC Connection Setup Complete message, and the communications device is configured to transmit the RRC Connection Setup Complete message, and to transition into a connected state in accordance with an RRC configuration used by the communications device the previous time the communications device was in the connected state.

In another arrangement of embodiments of the present technique, if the UE skips a PUR but receives an UL Grant during the PUR SS Window, the UE would transmit Msg5 using the resources indicated by the UL Grant. In other words, the communications device is configured to determine, if the communications device did not transmit uplink data in the PUR, that the uplink grant indicates that the communications device is to transmit the RRC Connection Setup Complete message.

In another arrangement of embodiments of the present technique, if the UE did NOT skip a PUR, then the UE monitors for two UL Grants, where the 1^{st} UL Grant contains the HARQ feedback (retransmission or explicit ACK) and the UE monitors for a potential subsequent 2^{nd} UL Grant in the PUR SS Window (if the PUR SS Window has not ended yet) where the 2^{nd} UL Grant is used to schedule resources for Msg5. In other words, if the communications device transmitted uplink data in the PUR, the uplink grant (that schedules the Msg5) is a second uplink grant received after a first uplink grant, and wherein the first uplink grant further comprises an indication of radio resources in which the communications device is to retransmit the uplink data if the feedback signal indicates that the uplink data has not been successfully received. In at least some implementations of this arrangement of embodiments of the present technique, the UE only monitors for a subsequent second UL Grant if its PUR SS collides with CSS Type 1. In other words, the communications device is configured to determine whether at least part of the PUR SS overlaps in time with at least part of a second set of radio resources of the wireless access interface forming a common search space, CSS, the CSS providing an opportunity for the communications device to receive the potential paging instruction, and to monitor the PUR SS for reception of the second uplink grant only if the communications device determines that the at least part of the PUR SS overlaps in time with the at least part of the CSS.

In another arrangement of embodiments of the present technique, the UE is configured by RRC whether the said potential paging instruction is an UL Grant for Msg3 or Msg5. In other words, the communications device is configured to receive RRC signalling comprising an indication of whether the communications device is to transmit, as the uplink signal, an RRC Connection Request message, or whether the communications device is to transmit, as the uplink signal, an RRC Connection Setup Complete message, wherein when RRC signalling indicates that the communications device is to transmit the RRC Connection Setup Complete message, the communications device uses an RRC configuration that had previously been stored by the communications device. Those skilled in the art would appreciate that, if the eNB configures the UE to transmit Msg5 using the said UL Grant, then the eNB also configures the UE to remember the RRC configuration when the UE moves into idle mode.

In another arrangement of embodiments of the present technique, the UL Grant sent to the UE during the PUR SS Window indicates whether the UL Grant is for Msg3 or Msg5. In other words, the uplink grant indicates either that the communications device is to transmit, as the uplink signal, an RRC Connection Request message, or that the communications device is to transmit, as the uplink signal, an RRC Connection Setup Complete message, wherein when the uplink grant indicates that the communications device is to transmit the RRC Connection Setup Complete message, the communications device uses an RRC configuration that had been previously stored by the communications device.

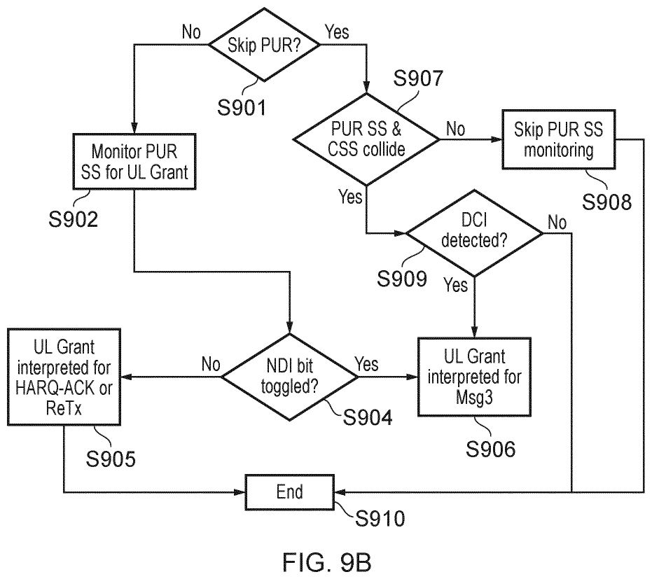

It should be appreciated that the UL Grant based arrangements above can be combined in various ways in implementations of wireless telecommunications systems which operate in accordance with embodiments of the present technique. An example implementation is shown in FIG. 9A, where the UE first determines in step S901 whether it has skipped a PUR. If the UE has not skipped the PUR, then it will monitor the PUR SS for an UL Grant in step S902. If the PUR SS Window collides with CSS Type 1, as determined by the UE in step S903, then in accordance with at least one of the above-described arrangements, it checks in step S904 whether the NDI bit of the detected DCI has been toggled. If the NDI bit has not been toggled, or if the PUR SS and CSS did not collide as determined in step S903, then the UE will use the UL Grant as a retransmission for its previous PUSCH in step S905. If the NDI bit has been toggled, the UE will interpret the UL Grant as indicating resources to transmit Msg3 in step S906. If the UE has skipped the PUR then it checks, in step S907 whether its PUR SS Window collides with CSS Type 1. If there is no collision then the UE does not need to monitor the PUR SS Window for that occasion. Otherwise if there is a collision the UE monitors, in step S909, the PUR SS Window for a DCI. If a DCI is detected then the UL Grant is again interpreted as indicating resources to transmit Msg3 in step S906. If no DCI is detected then it means the eNB did not page this UE and the process ends in step S910.

Another example implementation is shown in FIG. 9B, where the UE always monitors an UL Grant for potential paging instruction if it transmitted on PUR regardless of whether there is a collision between PUR SS & CSS Type 1. The flow chart is similar to that in FIG. 9A, except that if the UE did not skip a PUR, which is determined in step S901, it will still check whether there is a potential paging instruction (i.e. NDI bit toggled) regardless of whether there is a collision between PUR SS and CSS Type 1 or not (i.e. the UE does not carry out the check of step S903).

It should be appreciated that FIGS. 9A and 9B show only example implementations using some of the above arrangements of embodiments of the present technique and other combinations can be used.

Paging Instruction Using a Downlink Grant

In the following arrangements of embodiments of the present technique described in this section of the present disclosure, the said paging instruction is sent to the UE using a DL Grant. In other words, the potential paging instruction is received within a downlink grant and comprises an indication of radio resources of the wireless access interface within which the communications device is to receive a downlink signal.

In an arrangement of embodiments of the present technique, the said potential paging instruction is a DL Grant scheduling a PDSCH carrying a RAR (Random Access Response). The RAR provides an UL Grant for Msg3 which the UE would use to send an RRC Connection Request to the network. In other words, the downlink grant indicates that the communications device is to receive, as the downlink signal, a Random Access Response, RAR, message comprising an indication of radio resources of the wireless access interface within which the communications device is to transmit at least one uplink signal, where this uplink signal may be an RRC Connection Request message.

In another arrangement of embodiments of the present technique, the said potential paging instruction is a DL Grant scheduling a PDSCH carrying a RAR where the RAR can also indicate resources for the UE to retransmit its previous PUSCH in addition to resources to send Msg3 for RRC Connection Request. In other words, the at least one uplink signal comprises one or both of an RRC Connection Request message and, if the uplink data has not been successfully received, a retransmission of the uplink data.

In another arrangement of embodiments of the present technique, the said potential paging instruction is a DL Grant scheduling a PDSCH carrying Msg4 (RRC Connection Setup). Msg4 provides an RRC configuration for the UE to connect to the network. After receiving Msg4, the UE will monitor for an UL Grant that will schedule Msg5 as per legacy procedures. In other words, the downlink grant indicates that the communications device is to receive, as the downlink signal, an RRC Connection Setup message, and the communications device is configured to determine, from the RRC Connection Setup message, an RRC configuration to be used by the communications device after transitioning into a connected state, and to monitor for reception of an uplink grant comprising an indication of radio resources of the wireless access interface within which the communications device is to transmit an RRC Connection Setup Complete message. It would be appreciated by those skilled in the art that the network may wish to provide the UE with different RRC configurations (between the RRC configuration for PUR in IDLE mode and the RRC configuration for a normal RRC connection) and hence this arrangement may be preferable to the previously described arrangement above where the UE is directly assigned a Msg5 and the UE assumes that it uses the RRC configuration for PUR in IDLE mode.

In another arrangement of embodiments of the present technique, the UE monitors for a DCI Format 6-2 (paging DCI) when it has to monitor for MPDCCH in the PUR SS window. In other words, the communications device is configured to monitor, when the communications device monitors the PUR SS for reception of the potential paging instruction, the PUR SS for reception of a Downlink Control Information, DCI, message. The DCI Format 6-2 may schedule a PDSCH containing a paging instruction or it can be used for direct indication, i.e. indicate that there is change in one or more communications parameters, such as a System Information change.

In another arrangement of embodiments of the present technique if the UE skips the PUR, then it will not expect an UL Grant but instead it will monitor for a potential DL Grant. In other words, if the communications device did not transmit uplink data in the PUR, the potential paging instruction is received within a downlink grant and comprises an indication of radio resources of the wireless access interface within which the communications device is to receive a downlink signal.

In an arrangement of embodiments of the present technique, if the UE did not skip a PUR (i.e. transmits a PUSCH in the PUR), it will monitor for an UL Grant that carries the HARQ feedback (retransmission or explicit ACK) and a potential DL Grant carrying the paging instruction, i.e. in this case, the UE monitors for two different types of grant (1: UL grant, 2: DL grant). In other words, if the communications device transmitted uplink data in the PUR, the communications device is configured to monitor for reception of an uplink grant comprising the feedback signal, and to monitor for reception of a downlink grant comprising the potential paging instruction, the downlink grant comprising an indication of radio resources of the wireless access interface within which the communications device is to receive a downlink signal. In some implementations of this arrangement of embodiments of the present technique, the UE only monitors for a further DL Grant if its PUR SS collides with CSS Type 1. In other words, the communications device is configured to determine whether at least part of the PUR SS overlaps in time with at least part of a second set of radio resources of the wireless access interface forming a common search space, CSS, the CSS providing an opportunity for the communications device to receive the potential paging instruction, and to monitor the PUR SS for reception of the downlink grant only if the communications device determines that the at least part of the PUR SS overlaps in time with the at least part of the CSS.

It is under discussion whether a DL Grant for user traffic can be sent to the UE during the PUR SS. As proposed in [11], instead of sending a paging instruction, the eNB can send downlink user traffic to the UE directly. Hence, there may be a need to distinguish between a DL Grant for data and a DL Grant for paging instruction, i.e. Msg2 (RAR) or Msg4. In another arrangement of embodiments of the present technique, the DL Grant indicates whether the resources are for DL data or paging instruction. In other words, the communications device is configured to monitor for reception of a downlink grant comprising an indication of radio resources of the wireless access interface, wherein the downlink grant comprises an indication of whether the communications device is to receive, in the radio resources of the wireless access interface, the potential paging instruction or downlink data. In an implementation, a predefined TBS is used to implicitly indicate whether the DL Grant is for data or for Msg2 or Msg4, i.e. the TBS can also distinguish between Msg2 and Msg4.

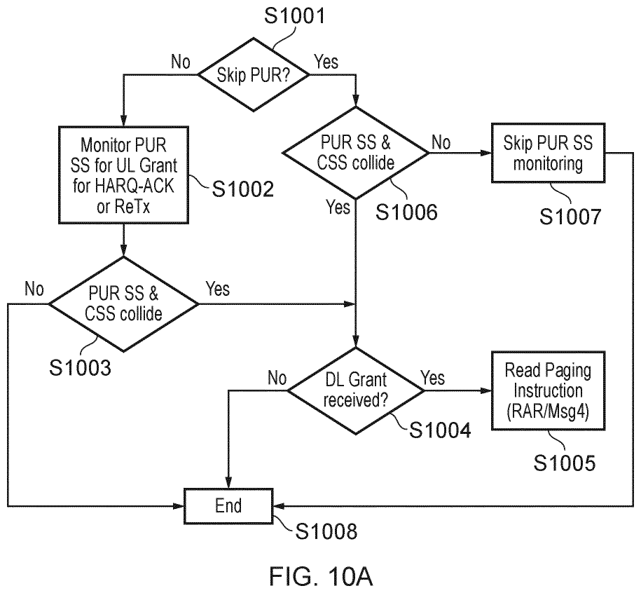

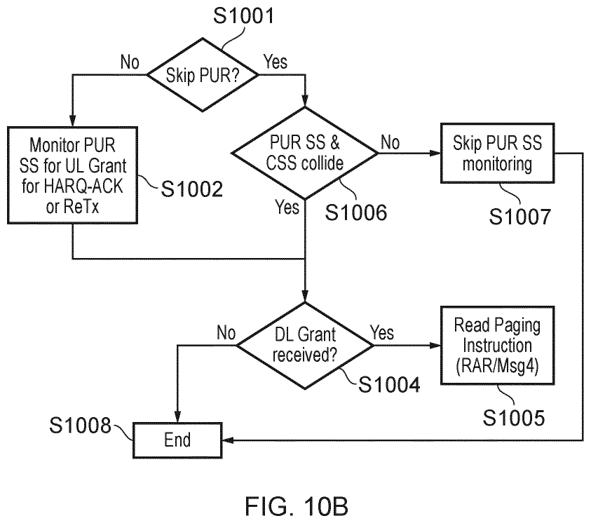

It should be appreciated that the DL Grant based arrangements can be combined in various ways in implementations of wireless telecommunications systems which operate in accordance with embodiments of the present technique. An example implementation is shown in FIG. 10A where in a PUR occasion the UE first determines in step S1001 whether it has skipped a PUR. If the UE did not skip a PUR (i.e. transmitted a PUSCH), it then monitors, in step S1002, the PUR SS Window for an UL Grant for retransmission or an explicit ACK. If the PUR SS Window collides with CSS Type 1 as determined by the UE in step S1003 then the UE will also monitor for a DL Grant in step S1004, otherwise the process ends in step S1008 and moves to the next PUR occasion. If a DL Grant is received the UE will read, in step S1005 the Paging Instruction in the scheduled PDSCH, which per the above described arrangements can be a Msg2 (RAR) or Msg4. If no DL Grant is received, this means the eNB did not page the UE and the process ends in step S1008. If the UE had skipped a PUR, it then determines whether its PUR SS Window collides with CSS Type 1 in step S1006. If the UE determined in step S1006 that the PUR SS and CSS did not collide, the UE does not need to monitor for the corresponding PUR SS in the PUR SS Window and so skips this (step S1007). Otherwise, the UE monitors for a DL Grant in the PUR SS Window for a possible Paging Instruction in step S1004. Again, if no DL Grant is received the process ends in step S1008, or otherwise the UE reads the Paging Instruction and performs an RRC Connection in accordance with step S1005.

Another example implementation is shown in FIG. 10B, where the UE monitors for potential paging instruction in a DL Grant if it has transmitted on a PUR regardless of whether its PUR SS collides with CSS Type 1. The flow chart is similar to that in FIG. 10A except that when the UE did not skip a PUR, which is determined in step S1001, it will still monitor for a DL grant after it has monitored for an UL Grant for HARQ-ACK feedback/Retransmission (i.e. the UE does not carry out the check of step S1003).

It should be appreciated that FIGS. 10A and 10B show only example implementations using some of the above arrangements of embodiments of the present technique and other combinations can be used.

Flow Chart Representation

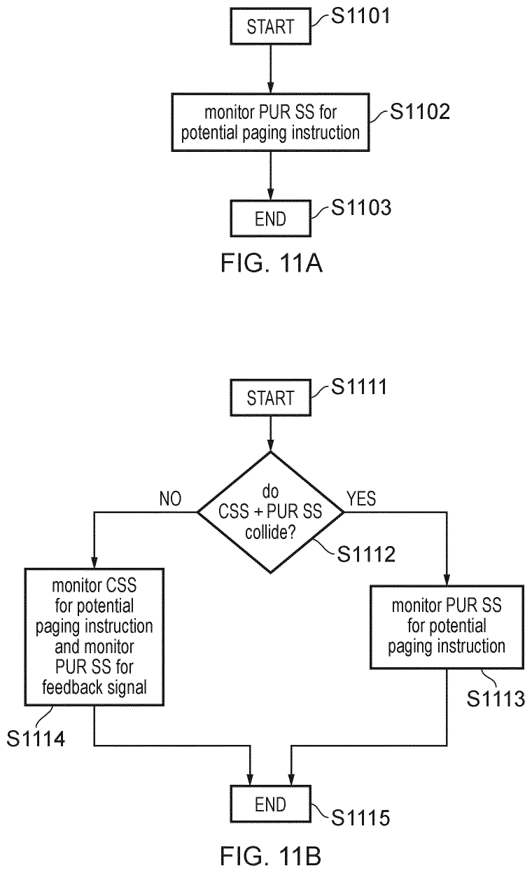

FIG. 11A shows a flow diagram illustrating a first example process of communications in a communications system in accordance with embodiments of the present technique. The process shown by FIG. 11A is a method of operating a communications device configured to transmit data to or receive data from an infrastructure equipment of a wireless communications network.

The method begins in step S1101. The method comprises, in step S1102, monitoring a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received. The method ends in step S1103.

FIG. 11B shows a flow diagram illustrating a second example process of communications in a communications system in accordance with embodiments of the present technique. The process shown by FIG. 11B is a method of operating a communications device configured to transmit data to or receive data from an infrastructure equipment of a wireless communications network.

The method begins in step S1111. The method comprises, in step S1112, determining whether at least part of a first set of radio resources of a wireless access interface of the wireless communications network forming a preconfigured uplink resource, PUR, search space, SS, overlaps in time with at least part of a second set of radio resources of the wireless access interface forming a common search space, CSS, the PUR SS being associated with a PUR in which the communications device may optionally transmit uplink data to the infrastructure equipment and comprising, when the communications device transmits the uplink data to the infrastructure equipment, a feedback signal, transmitted by the infrastructure equipment, indicating whether or not the uplink data has been successfully received by the infrastructure equipment, and the CSS providing an opportunity for the communications device to receive a potential paging instruction from the infrastructure equipment. If the communications device determines that the at least part of the PUR SS overlaps in time with the at least part of the CSS, the process moves to step S1113, which comprises monitoring the PUR SS for reception of the potential paging instruction from the infrastructure equipment. If the communications device determines that the at least part of the PUR SS does not overlap in time with the at least part of the CSS however, the process moves instead to step S1114, which comprises, in accordance with normal operations, monitoring the CSS for reception of the potential paging instruction from the infrastructure equipment, and if the communications device has transmitted the uplink data to the infrastructure equipment, monitoring the PUR SS for the feedback signal from the infrastructure equipment. The method ends in step S1115.

Those skilled in the art would appreciate that the methods shown by FIGS. 11A and 11B may be adapted in accordance with embodiments of the present technique. For example, other intermediate steps may be included in the method, or the steps may be performed in any logical order.

Though embodiments of the present technique have been described largely by way of the example communications systems shown in FIGS. 7A and 7B, and in accordance with the examples of FIGS. 8 to 10, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A communications device configured to transmit data or receive data, the communications device comprising
transceiver circuitry configured to transmit signals and receive signals via a wireless access interface, and
controller circuitry configured in combination with the transceiver circuitry
to monitor a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received.

Paragraph 2. A communications device according to Paragraph 1, wherein the communications device is configured
to monitor the PUR SS for reception of the potential paging instruction only if the communications device transmitted uplink data in the PUR.

Paragraph 3. A communications device according to Paragraph 1, wherein the communications device is configured
to determine whether at least part of the PUR SS overlaps in time with at least part of a second set of radio resources of the wireless access interface forming a common search space, CSS, the CSS providing an opportunity for the communications device to receive the potential paging instruction, and
to monitor the PUR SS for reception of the potential paging instruction only if the communications device determines that the at least part of the PUR SS overlaps in time with the at least part of the CSS.

Paragraph 4. A communications device according to Paragraph 3, wherein the communications device is configured
to monitor the PUR SS for reception of the potential paging instruction only if the communications device transmitted uplink data in the PUR.

Paragraph 5. A communications device according to any of Paragraphs 1 to 4, wherein the potential paging instruction is received within an uplink grant and comprises an indication of radio resources of the wireless access interface within which the communications device is to transmit an uplink signal, and wherein, if the communications device transmitted uplink data in the PUR, the uplink grant comprises the feedback signal.

Paragraph 6. A communications device according to Paragraph 5, wherein the uplink grant indicates that the communications device is to transmit, as the uplink signal, a Radio Resource Control, RRC, Connection Request message.

Paragraph 7. A communications device according to Paragraph 6, wherein the communications device is configured
to determine whether the communications device does not have a valid timing advance, and
to transmit, if the communications device determines that it does not have a valid timing advance, a preamble signal.

Paragraph 8. A communications device according to Paragraph 6 or Paragraph 7, wherein the communications device is configured to determine, if the communications device did not transmit uplink data in the PUR, that the uplink grant indicates that the communications device is to transmit the RRC Connection Request message.

Paragraph 9. A communications device according to any of Paragraphs 5 to 8, wherein, if the communications device transmitted uplink data in the PUR, the uplink grant is a second uplink grant received after a first uplink grant, and wherein the first uplink grant further comprises an indication of radio resources in which the communications device is to retransmit the uplink data if the feedback signal indicates that the uplink data has not been successfully received.

Paragraph 10. A communications device according to Paragraph 9, wherein the communications device is configured
to determine whether at least part of the PUR SS overlaps in time with at least part of a second set of radio resources of the wireless access interface forming a common search space, CSS, the CSS providing an opportunity for the communications device to receive the potential paging instruction, and
to monitor the PUR SS for reception of the second uplink grant only if the communications device determines that the at least part of the PUR SS overlaps in time with the at least part of the CSS. Paragraph 11. A communications device according to any of Paragraphs 5 to 10, wherein the uplink grant indicates that the communications device is to transmit, as the uplink signal, an RRC Connection Setup Complete message, and the communications device is configured
to transmit the RRC Connection Setup Complete message, and
to transition into a connected state in accordance with an RRC configuration used by the communications device the previous time the communications device was in the connected state.

Paragraph 12. A communications device according to Paragraph 11, wherein the communications device is configured to determine, if the communications device did not transmit uplink data in the PUR, that the uplink grant indicates that the communications device is to transmit the RRC Connection Setup Complete message.

Paragraph 13. A communications device according to any of Paragraphs 5 to 12, wherein the communications device is configured to receive RRC signalling comprising an indication of whether the communications device is to transmit, as the uplink signal, an RRC Connection Request message, or whether the communications device is to transmit, as the uplink signal, an RRC Connection Setup Complete message, wherein when RRC signalling indicates that the communications device is to transmit the RRC Connection Setup Complete message, the communications device uses an RRC configuration that had been previously stored by the communications device.

Paragraph 14. A communications device according to any of Paragraphs 5 to 12, wherein the uplink grant indicates either that the communications device is to transmit, as the uplink signal, an RRC Connection Request message, or that the communications device is to transmit, as the uplink signal, an RRC Connection Setup Complete message, wherein when the uplink grant indicates that the communications device is to transmit the RRC Connection Setup Complete message, the communications device uses an RRC configuration that had been previously stored by the communications device.

Paragraph 15. A communications device according to any of Paragraphs 1 to 13, wherein, if the communications device transmitted uplink data in the PUR, the communications device is configured to receive an uplink grant within the PUR SS, the uplink grant comprising an indication of radio resources of the wireless access interface and an indicator indicating whether the uplink grant comprises the potential paging instruction and therefore that the communications device is to transmit one of an RRC Connection Request and an RRC Connection Setup Complete message in the indicated radio resources or whether the uplink grant comprises the feedback signal and therefore that, if the feedback signal indicates that the uplink data has not been successfully received, the communications device is to retransmit the uplink data in the indicated radio resources.

Paragraph 16. A communications device according to Paragraph 15, wherein the indicator comprises a bit which is toggled each time the communications device is to transmit a new uplink signal.

Paragraph 17. A communications device according to any of Paragraphs 1 to 16, wherein, if the communications device transmitted uplink data in the PUR, the communications device is configured to receive an uplink grant within the PUR SS, the uplink grant comprising both of the potential paging instruction and the feedback signal and an indication of a set of radio resources of the wireless access interface.

Paragraph 18. A communications device according to Paragraph 17, wherein the communications device is configured to determine, if the uplink grant indicates that the communications device is to transmit only an RRC Connection Request message within the set of radio resources, that the feedback signal indicates that the uplink data has been successfully received.

Paragraph 19. A communications device according to Paragraph 17 or Paragraph 18, wherein the uplink grant indicates that the communications device is to transmit an RRC Connection Request message within the set of radio resources and that the communications device is to retransmit the uplink data within the set of radio resources.

Paragraph 20. A communications device according to any of Paragraphs 17 to 19, wherein the uplink grant indicates that the communications device is to only retransmit the uplink data within the set of radio resources.

Paragraph 21. A communications device according to any of Paragraphs 17 to 20, wherein the feedback signal comprised within the uplink grant is an explicit acknowledgement that the uplink data was successfully received.

Paragraph 22. A communications device according to any of Paragraphs 1 to 4, wherein the potential paging instruction is received within a downlink grant and comprises an indication of radio resources of the wireless access interface within which the communications device is to receive a downlink signal.

Paragraph 23. A communications device according to Paragraph 22, wherein the downlink grant indicates that the communications device is to receive, as the downlink signal, a Random Access Response, RAR, message comprising an indication of radio resources of the wireless access interface within which the communications device is to transmit at least one uplink signal.

Paragraph 24. A communications device according to Paragraph 23, wherein the at least one uplink signal comprises one or both of an RRC Connection Request message and, if the uplink data has not been successfully received, a retransmission of the uplink data.

Paragraph 25. A communications device according to any of Paragraphs 22 to 24, wherein the downlink grant indicates that the communications device is to receive, as the downlink signal, an RRC Connection Setup message, and the communications device is configured
to determine, from the RRC Connection Setup message, an RRC configuration to be used by the communications device after transitioning into a connected state, and
to monitor for reception of an uplink grant comprising an indication of radio resources of the wireless access interface within which the communications device is to transmit an RRC Connection Setup Complete message.

Paragraph 26. A communications device according to any of Paragraphs 22 to 25, wherein the communications device is configured
to monitor for reception of a downlink grant comprising an indication of radio resources of the wireless access interface, wherein the downlink grant comprises an indication of whether the communications device is to receive, in the radio resources of the wireless access interface, the potential paging instruction or downlink data.

Paragraph 27. A communications device according to any of Paragraphs 1 to 26, wherein, if the communications device did not transmit uplink data in the PUR, the potential paging instruction is received within a downlink grant and comprises an indication of radio resources of the wireless access interface within which the communications device is to receive a downlink signal.

Paragraph 28. A communications device according to any of Paragraphs 1 to 27, wherein, if the communications device transmitted uplink data in the PUR, the communications device is configured
to monitor for reception of an uplink grant comprising the feedback signal, and
to monitor for reception of a downlink grant comprising the potential paging instruction, the downlink grant comprising an indication of radio resources of the wireless access interface within which the communications device is to receive a downlink signal.

Paragraph 29. A communications device according to Paragraph 28, wherein the communications device is configured
to determine whether at least part of the PUR SS overlaps in time with at least part of a second set of radio resources of the wireless access interface forming a common search space, CSS, the CSS providing an opportunity for the communications device to receive the potential paging instruction, and
to monitor the PUR SS for reception of the downlink grant only if the communications device determines that the at least part of the PUR SS overlaps in time with the at least part of the CSS.

Paragraph 30. A communications device according to any of Paragraphs 1 to 29, wherein the communications device is configured
to monitor, when the communications device monitors the PUR SS for reception of the potential paging instruction, the PUR SS for reception of a Downlink Control Information, DCI, message.

Paragraph 31. A communications device according to Paragraph 30, wherein the potential paging instruction is received within the DCI message.

Paragraph 32. A communications device according to Paragraph 30 or Paragraph 31, wherein the DCI message is a direct indication to the communications device and comprises an indication of a change in one or more communications parameters.

Paragraph 33. A method of operating a communications device configured to transmit data to or receive data from an infrastructure equipment of a wireless communications network, the method comprising
monitoring a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received.

Paragraph 34. Circuitry for a communications device configured to transmit data or receive data, the communications device comprising
transceiver circuitry configured to transmit signals and receive signals via a wireless access interface, and
controller circuitry configured in combination with the transceiver circuitry
to monitor a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received.

Paragraph 35. An infrastructure equipment forming part of a wireless communications network, the infrastructure equipment configured to transmit data or receive data and comprising
transceiver circuitry configured to transmit signals and receive signals via a wireless access interface provided by the wireless communications network, and
controller circuitry configured in combination with the transceiver circuitry
to transmit a paging instruction in a first set of radio resources of the wireless access interface, the first set of radio resources forming a preconfigured uplink resource, PUR, search space, SS, associated with a PUR in which the infrastructure equipment may receive optionally transmitted uplink data and within which, when the infrastructure equipment receives the uplink data, the infrastructure equipment is configured to transmit a feedback signal indicating whether or not the uplink data has been successfully received.

Paragraph 36. An infrastructure equipment according to Paragraph 35, wherein the infrastructure equipment is configured
to transmit the paging instruction in the PUR SS only if the infrastructure equipment received the uplink data in the PUR.

Paragraph 37. An infrastructure equipment according to Paragraph 35 or Paragraph 36, wherein the infrastructure equipment is configured
to determine whether at least part the PUR SS overlaps in time with at least part of a second set of radio resources of the wireless access interface forming a common search space, CSS, the CSS providing an opportunity for the infrastructure equipment to transmit the potential paging instruction, and
to transmit the paging instruction in the PUR SS only if the infrastructure equipment determines that the at least part of the PUR SS overlaps in time with the at least part of the CSS.

Paragraph 38. A method of operating an infrastructure equipment forming part of a wireless communications network, the infrastructure equipment configured to transmit data or receive data, the method comprising
transmitting a paging instruction in a first set of radio resources of the wireless access interface, the first set of radio resources forming a preconfigured uplink resource, PUR, search space, SS, associated with a PUR in which the infrastructure equipment may receive optionally transmitted uplink data and within which, when the infrastructure equipment receives the uplink data, the infrastructure equipment is configured to transmit a feedback signal indicating whether or not the uplink data has been successfully received.

Paragraph 39. Circuitry for an infrastructure equipment forming part of a wireless communications network, the infrastructure equipment configured to transmit data or receive data and comprising
transceiver circuitry configured to transmit signals and receive signals via a wireless access interface provided by the wireless communications network, and
controller circuitry configured in combination with the transceiver circuitry
to transmit a paging instruction in a first set of radio resources of the wireless access interface, the first set of radio resources forming a preconfigured uplink resource, PUR, search space, SS, associated with a PUR in which the infrastructure equipment may receive optionally transmitted uplink data and within which, when the infrastructure equipment receives the uplink data, the infrastructure equipment is configured to transmit a feedback signal indicating whether or not the uplink data has been successfully received.

Paragraph 40. A communications device configured to transmit data or receive data, the communications device comprising
transceiver circuitry configured to transmit signals and receive signals via a wireless access interface, and
controller circuitry configured in combination with the transceiver circuitry
to determine whether at least part of a first set of radio resources of the wireless access interface forming a preconfigured uplink resource, PUR, search space, SS, overlaps in time with at least part of a second set of radio resources of the wireless access interface forming a common search space, CSS, the PUR SS being associated with a PUR in which the communications device may optionally transmit uplink data and comprising, when the communications device transmits the uplink data, a feedback signal indicating whether or not the uplink data has been successfully received, and the CSS providing an opportunity for the communications device to receive the potential paging instruction,
to determine, if the communications device determines that the at least part of the PUR SS overlaps in time with the at least part of the CSS, that the communications device has not transmitted uplink data in the PUR, and
to monitor the CSS for reception of the potential paging instruction.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] RP-161464, “Revised WID for Further Enhanced MTC for LTE,” Ericsson, 3GPP TSG RAN Meeting #73, New Orleans, USA, Sep. 19-22, 2016.
[2] RP-161901, “Revised work item proposal: Enhancements of NB-IoT”, Huawei, HiSilicon, 3GPP TSG RAN Meeting #73, New Orleans, USA, Sep. 19-22, 2016.
[3] RP-170732, “New WID on Even further enhanced MTC for LTE,” Ericsson, Qualcomm, 3GPP TSG RAN Meeting #75, Dubrovnik, Croatia, Mar. 6-9, 2017.
[4] RP-170852, “New WID on Further NB-IoT enhancements,” Huawei, HiSilicon, Neul, 3GPP TSG RAN Meeting #75, Dubrovnik, Croatia, Mar. 6-9, 2017.
[5] RP-191356, “Additional MTC enhancements for LTE,” Ericsson, 3GPP TSG RAN Meeting #84, Newport Beach, USA, Jun. 3-6, 2019.
[6] RP-191576, “Additional enhancements for NB-IoT,” Huawei, 3GPP TSG RAN Meeting #84, Newport Beach, USA, Jun. 3-6, 2019.
[7] Holma H. and Toskala A, “LTE for UMTS OFDMA and SC-FDMA based radio access”, John Wiley and Sons, 2009.
[8] T536.212, “E-UTRA: Multiplexing and channel coding (Release 15)”.
[9] Sesia S. et al., “LTE—The UMTS Long Term Evolution: From Theory to Practice”, 2^{nd} edition, 2009.
[10] R1-1906460, “LTE-M Pre-configured UL Resources Design Considerations,” Sierra Wireless, S.A, RAN1 #97.
[11] R1-1906496, “Support for transmission in preconfigured UL resources for MTC,” ZTE, RAN1 #97.
[12] R1-1906682, “Discussion on preconfigured UL resources in MTC,” LG Electronics, RAN1 #97.

1. A communications device configured to transmit data or receive data, the communications device comprising
transceiver circuitry configured to transmit signals and receive signals via a wireless access interface, and
controller circuitry configured in combination with the transceiver circuitry
to monitor a first set of radio resources of the wireless access interface for reception of a potential paging instruction, the first set of radio resources forming a preconfigured uplink resource, PUR, search space, SS, associated with a PUR in which the communications device may optionally transmit uplink data and comprising, when the communications device transmits the uplink data, a feedback signal indicating whether or not the uplink data has been successfully received.

2. A communications device according to claim 1, wherein the communications device is configured
to monitor the PUR SS for reception of the potential paging instruction only if the communications device transmitted uplink data in the PUR.

3. A communications device according to claim 1, wherein the communications device is configured
to determine whether at least part of the PUR SS overlaps in time with at least part of a second set of radio resources of the wireless access interface forming a common search space, CSS, the CSS providing an opportunity for the communications device to receive the potential paging instruction, and
to monitor the PUR SS for reception of the potential paging instruction only if the communications device determines that the at least part of the PUR SS overlaps in time with the at least part of the CSS.

4. A communications device according to claim 3, wherein the communications device is configured
to monitor the PUR SS for reception of the potential paging instruction only if the communications device transmitted uplink data in the PUR.

5. A communications device according to claim 1, wherein the potential paging instruction is received within an uplink grant and comprises an indication of radio resources of the wireless access interface within which the communications device is to transmit an uplink signal, and wherein, if the communications device transmitted uplink data in the PUR, the uplink grant comprises the feedback signal.

6. A communications device according to claim 5, wherein the uplink grant indicates that the communications device is to transmit, as the uplink signal, a Radio Resource Control, RRC, Connection Request message.

7. A communications device according to claim 6, wherein the communications device is configured
to determine whether the communications device does not have a valid timing advance, and
to transmit, if the communications device determines that it does not have a valid timing advance, a preamble signal.

8. A communications device according to claim 6, wherein the communications device is configured to determine, if the communications device did not transmit uplink data in the PUR, that the uplink grant indicates that the communications device is to transmit the RRC Connection Request message.

9. A communications device according to claim 5, wherein, if the communications device transmitted uplink data in the PUR, the uplink grant is a second uplink grant received after a first uplink grant, and wherein the first uplink grant further comprises an indication of radio resources in which the communications device is to retransmit the uplink data if the feedback signal indicates that the uplink data has not been successfully received.

10. A communications device according to claim 9, wherein the communications device is configured
to determine whether at least part of the PUR SS overlaps in time with at least part of a second set of radio resources of the wireless access interface forming a common search space, CSS, the CSS providing an opportunity for the communications device to receive the potential paging instruction, and
to monitor the PUR SS for reception of the second uplink grant only if the communications device determines that the at least part of the PUR SS overlaps in time with the at least part of the CSS.

11. A communications device according to claim 5, wherein the uplink grant indicates that the communications device is to transmit, as the uplink signal, an RRC Connection Setup Complete message, and the communications device is configured
to transmit the RRC Connection Setup Complete message, and
to transition into a connected state in accordance with an RRC configuration used by the communications device the previous time the communications device was in the connected state.

12. A communications device according to claim 11, wherein the communications device is configured to determine, if the communications device did not transmit uplink data in the PUR, that the uplink grant indicates that the communications device is to transmit the RRC Connection Setup Complete message.

13. A communications device according to claim 5, wherein the communications device is configured to receive RRC signalling comprising an indication of whether the communications device is to transmit, as the uplink signal, an RRC Connection Request message, or whether the communications device is to transmit, as the uplink signal, an RRC Connection Setup Complete message, wherein when RRC signalling indicates that the communications device is to transmit the RRC Connection Setup Complete message, the communications device uses an RRC configuration that had been previously stored by the communications device.

14. A communications device according to claim 5, wherein the uplink grant indicates either that the communications device is to transmit, as the uplink signal, an RRC Connection Request message, or that the communications device is to transmit, as the uplink signal, an RRC Connection Setup Complete message, wherein when the uplink grant indicates that the communications device is to transmit the RRC Connection Setup Complete message, the communications device uses an RRC configuration that had been previously stored by the communications device.

15. A communications device according to claim 1, wherein, if the communications device transmitted uplink data in the PUR, the communications device is configured to receive an uplink grant within the PUR SS, the uplink grant comprising an indication of radio resources of the wireless access interface and an indicator indicating whether the uplink grant comprises the potential paging instruction and therefore that the communications device is to transmit one of an RRC Connection Request and an RRC Connection Setup Complete message in the indicated radio resources or whether the uplink grant comprises the feedback signal and therefore that, if the feedback signal indicates that the uplink data has not been successfully received, the communications device is to retransmit the uplink data in the indicated radio resources.

16. (canceled)

17. A communications device according to claim 1, wherein, if the communications device transmitted uplink data in the PUR, the communications device is configured to receive an uplink grant within the PUR SS, the uplink grant comprising both of the potential paging instruction and the feedback signal and an indication of a set of radio resources of the wireless access interface.

18.-34. (canceled)

35. An infrastructure equipment forming part of a wireless communications network, the infrastructure equipment configured to transmit data or receive data and comprising
transceiver circuitry configured to transmit signals and receive signals via a wireless access interface provided by the wireless communications network, and
controller circuitry configured in combination with the transceiver circuitry
to transmit a paging instruction in a first set of radio resources of the wireless access interface, the first set of radio resources forming a preconfigured uplink resource, PUR, search space, SS, associated with a PUR in which the infrastructure equipment may receive optionally transmitted uplink data and within which, when the infrastructure equipment receives the uplink data, the infrastructure equipment is configured to transmit a feedback signal indicating whether or not the uplink data has been successfully received.

36. An infrastructure equipment according to claim 35, wherein the infrastructure equipment is configured
to transmit the paging instruction in the PUR SS only if the infrastructure equipment received the uplink data in the PUR.

37. An infrastructure equipment according to claim 35, wherein the infrastructure equipment is configured
to determine whether at least part the PUR SS overlaps in time with at least part of a second set of radio resources of the wireless access interface forming a common search space, CSS, the CSS providing an opportunity for the infrastructure equipment to transmit the potential paging instruction, and
to transmit the paging instruction in the PUR SS only if the infrastructure equipment determines that the at least part of the PUR SS overlaps in time with the at least part of the CSS.

38. A method of operating an infrastructure equipment forming part of a wireless communications network, the infrastructure equipment configured to transmit data or receive data, the method comprising
transmitting a paging instruction in a first set of radio resources of the wireless access interface, the first set of radio resources forming a preconfigured uplink resource, PUR, search space, SS, associated with a PUR in which the infrastructure equipment may receive optionally transmitted uplink data and within which, when the infrastructure equipment receives the uplink data, the infrastructure equipment is configured to transmit a feedback signal indicating whether or not the uplink data has been successfully received.

39.-40. (canceled)
